(19) United States
(12) Patent Application Publication
(10) Pub. No.: US 2026/0003256 A1
(43) Pub. Date: Jan. 1, 2026

(54) LIGHT SOURCE APPARATUS AND PROJECTOR

(71) Applicant: SEIKO EPSON CORPORATION, Tokyo (JP)

(72) Inventor: Tomohiro YOKOO, MATSUMOTO-SHI (JP)

(21) Appl. No.: 19/245,888

(22) Filed: Jun. 23, 2025

(30) Foreign Application Priority Data
Jun. 26, 2024 (JP) 2024-102836

(51) Int. Cl. G03B 21/20

(52) U.S. Cl. CPC G03B 21/204; G03B 21/2013; G03B 21/2066

(57) ABSTRACT

A light source apparatus according to an aspect of the present disclosure includes a first light source configured to emit first light; a first wavelength converter configured to convert the first light into second light; a first optical layer configured to transmit the first light and reflect the second light; a light guide configured to guide the second light; a second wavelength converter configured to convert the first light into third light; a second optical layer configured to reflect the second light and the third light; and a first reflection member. The first wavelength converter has a first surface on which the first light is incident via the first optical layer, and a second surface and a third surface that intersect with the first surface and face opposite sides, the first reflection member is disposed in a region of the light guide, at a side of the second surface, and the second light and the third light travel through the light guide and exit via a region of the light guide, at a side of the third surface.

The present application is based on, and claims priority from JP Application Serial Number 2024-102836, filed Jun. 26, 2024, the disclosure of which is hereby incorporated by reference herein in its entirety.

### BACKGROUND

### 1. Technical Field

The present disclosure relates to a light source apparatus and a projector.

### 2. Related Art

As a light source apparatus used in a projector, there has been a proposed light source apparatus using fluorescence emitted from a phosphor when the phosphor is irradiated with excitation light emitted from a light emitter. WO 2006/054203 described below discloses a light source apparatus including a wavelength converting member that has the shape of a planar plate and contains a phosphor, and a light emitting diode that emits excitation light. In the light source apparatus, out of the multiple surfaces of the wavelength converting member, the excitation light is caused to enter via a light incident surface having a larger area, and fluorescence is emitted via a light emission surface having a smaller area.

WO 2006/054203 is an example of the related art.

In the light source apparatus disclosed in WO 2006/054203, the fluorescence generated in the wavelength converting member is totally reflected off the interfaces between the surfaces of the wavelength converting member and an air layer, therefore propagates through the interior of the wavelength converting member, and exits via the light emission surface. However, components of the fluorescence that are incident on the interfaces between the wavelength converting member and the air layer at angles smaller than the critical angle are not totally reflected off the interfaces, and therefore leak to the outside via the interfaces before reaching the light emission surface. There is therefore a problem of reduced fluorescence use efficiency.

### SUMMARY

To solve the problem described above, a light source apparatus according to an aspect of the present disclosure includes: a first light source configured to emit first light having a first wavelength band; a first wavelength converter configured to convert the first light into second light having a second wavelength band different from the first wavelength band; a first optical layer disposed between the first light source and the first wavelength converter and configured to transmit the first light and reflect the second light; a light guide disposed on a side opposite the first optical layer with the first wavelength converter disposed therebetween and configured to guide the second light as a result of conversion performed by the first wavelength converter; a second wavelength converter disposed on a side opposite the first wavelength converter with the light guide disposed therebetween and configured to convert the first light incident via the first wavelength converter and the light guide into third light having a third wavelength band different from the first wavelength band; a second optical layer disposed on a side opposite the light guide with the second wavelength converter disposed therebetween and configured to reflect the second light and the third light; and a first reflection member configured to reflect the first light, the second light, and the third light, the first wavelength converter having a first surface on which the first light is incident via the first optical layer, and a second surface and a third surface that intersect with the first surface and face opposite sides, the first reflection member being disposed in a region of the light guide, at a side of the second surface, and the second light as a result of conversion performed by the first wavelength converter and the third light as a result of conversion performed by the second wavelength converter traveling through the light guide and exiting via a region of the light guide, at a side of the third surface.

A projector according to another aspect of the present disclosure includes the light source apparatus according to the aspect of the present disclosure; a light modulator configured to modulate light emitted from the light source apparatus; and a projection optical apparatus configured to project the light modulated by the light modulator.

### BRIEF DESCRIPTION OF THE DRAWINGS

FIG. 1 is a schematic configuration diagram of a projector according to a first embodiment.

FIG. 2 is a cross-sectional view of a light source apparatus according to the first embodiment.

FIG. 3 is a cross-sectional view of the light source apparatus taken along the line III-III in FIG. 2.

FIG. 4 is a plan view of the light source apparatus viewed from a +X side toward a −X side.

FIG. 5 is a cross-sectional view of a light source apparatus according to a second embodiment.

FIG. 6 is a cross-sectional view of a light source apparatus according to a third embodiment.

FIG. 7 is a cross-sectional view of a light source apparatus according to a fourth embodiment.

FIG. 8 is a cross-sectional view of a light source apparatus according to a fifth embodiment.

FIG. 9 is a cross-sectional view of a light source apparatus according to a sixth embodiment.

### DESCRIPTION OF EMBODIMENTS

### First Embodiment

A first embodiment of the present disclosure will be described below with reference to the drawings.

A projector according to the present embodiment is an example of a projector using liquid crystal panels as light modulators.

In the following drawings, elements may be drawn at different dimensional scales for clarity of the elements.

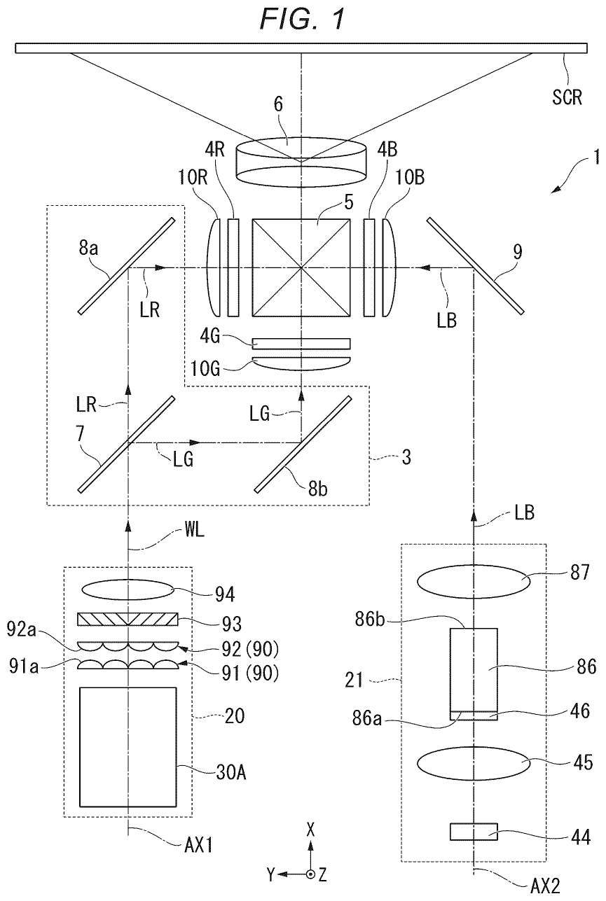

FIG. 1 is a schematic configuration diagram of a projector 1 according to the present embodiment.

As shown in FIG. 1, the projector 1 according to the present embodiment is a projection-type image display apparatus that displays a color image on a screen SCR, which is a projection receiving surface. The projector 1 includes three light modulators corresponding to three types of color light, red light LR, green light LG, and blue light LB.

The projector 1 includes a first illuminator 20, a second illuminator 21, a color separation system 3, a light modulator 4R, a light modulator 4G, a light modulator 4B, a light combiner 5, and a projection optical apparatus 6.

The first Illuminator 20 emits yellow illumination light WL toward the color separation system 3. The second Illuminator 21 emits the blue light LB toward the light modulator 4B. Detailed configurations of the first illuminator 20 and the second illuminator 21 will be described later.

In the following drawings, the description will be made by using an XYZ orthogonal coordinate system as necessary. The Z-axis is an axis along the upward-downward direction of the projector 1. The X-axis is an axis parallel to an optical axis AX1 of the first illuminator 20 and an optical axis AX2 of the second illuminator 21. The Y-axis is an axis orthogonal to the X-axis and the Z-axis. The optical axis AX1 of the first illuminator 20 is the center axis of fluorescence Y emitted from the first illuminator 20. The optical axis AX2 of the second illuminator 21 is the center axis of the blue light LB emitted from the second illuminator 21. One of the two directions along the X-axis is referred to as a +X direction, the direction opposite the +X direction is referred to as a −X direction, one of the two directions along the Y-axis is referred to as a +Y direction, the direction opposite the +Y direction is referred to as a −Y direction, one of the two directions along the Z-axis is referred to as a +Z direction, and the direction opposite the +Z direction is referred to as a −Z direction. The two directions along the X-axis are referred to as an X-axis direction when not distinguished from each other but are collectively referred to, the two directions along the Y-axis are referred to as a Y-axis direction when not distinguished from each other but are collectively referred to, and the two directions along the Z-axis are referred to as a Z-axis direction when not distinguished from each other but are collectively referred to.

The color separation system 3 separates the yellow illumination light WL emitted from the first Illuminator 20 into the red light LR and the green light LG. The color separation system 3 includes a dichroic mirror 7, a first reflection mirror 8a, and a second reflection mirror 8b.

The dichroic mirror 7 separates the illumination light WL into the red light LR and the green light LG. The dichroic mirror 7 transmits the red light LR and reflects the green light LG. The second reflection mirror 8b is disposed in the optical path of the green light LG. The second reflection mirror 8b receives the green light LG reflected off the dichroic mirror 7 and reflects the green light LG toward the light modulator 4G. The first reflection mirror 8a is disposed in the optical path of the red light LR. The first reflection mirror 8a receives the red light LR having passed through the dichroic mirror 7 and reflects the red light LR toward the light modulator 4R.

In contrast, the blue light LB emitted from the second illuminator 21 is reflected off a reflection mirror 9 toward the light modulator 4B.

The configuration of the second illuminator 21 will be described below.

The second illuminator 21 includes a light source section 44, a light collecting lens 45, a diffuser plate 46, a rod lens 86, and a relay lens 87. The light source section 44 is configured with at least one semiconductor laser. The light source section 44 emits the blue light LB, which is laser light. Note that the light source section 44 is not necessarily configured with a semiconductor laser, and may be configured with an LED that emits blue light.

The light collecting lens 45 is configured with a convex lens. The light collecting lens 45 causes the blue light LB emitted from the light source section 44 to be incident on the diffuser plate 46 with the blue light LB substantially collected at the diffuser plate 46. The diffuser plate 46 diffuses the blue light LB emitted from the light collecting lens 45 into blue light LB diffused by a predetermined degree to generate blue light LB having a substantially uniform light orientation distribution substantially the same as that of the illumination light WL emitted from the first illuminator 20. The diffuser plate 46 is, for example, a ground glass plate made of optical glass.

The blue light LB diffused by the diffuser plate 46 enters the rod lens 86. The rod lens 86 has a quadrangular columnar shape extending along the direction of the optical axis AX2 of the second illuminator 21. The rod lens 86 has a light incident end surface 86a provided at one end and a light emission end surface 86b provided at the other end. The diffuser plate 46 is fixed to the light incident end surface 86a of the rod lens 86 via an optical adhesive (not shown). It is desirable that the refractive index of the diffuser plate 46 matches as much as possible with the refractive index of the rod lens 86.

The blue light LB propagates through the interior of the rod lens 86 while being totally reflected therein and exits via the light emission end surface 86b with the resultant illuminance distribution of the blue light LB having enhanced uniformity. The blue light LB emitted from the rod lens 86 enters the relay lens 87. The relay lens 87 causes the blue light LB having the illuminance distribution enhanced in terms of uniformity by the rod lens 86 to be incident on the reflection mirror 9.

The light emission end surface 86b of the rod lens 86 has a rectangular shape substantially similar to the shape of an image formation region of the light modulator 4B. The blue light LB emitted from the rod lens 86 is thus efficiently incident on the image formation region of the light modulator 4B.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers (not shown) are disposed at the light incident side and the light exiting side of each of the liquid crystal panels. The polarizers transmit only linearly polarized light polarized in a specific direction.

A field lens 10R is disposed on the light incident side of the light modulator 4R. A field lens 10G is disposed on the light incident side of the light modulator 4G. A field lens 10B is disposed on the light incident side of the light modulator 4B. The field lens 10R parallelizes the chief ray of the red light LR to be incident on the light modulator 4R. The field lens 10G parallelizes the chief ray of the green light LG to be incident on the light modulator 4G. The field lens 10B parallelizes the chief ray of the blue light LB to be incident on the light modulator 4B.

When the image light emitted from the light modulator 4R, the image light emitted from the light modulator 4G, and the image light emitted from the light modulator 4B enter the light combiner 5, the light combiner 5 combines the image light corresponding to the red light LR, the image light corresponding to the green light LG, and the image light corresponding to the blue light LB with one another and emits the combined image light toward the projection optical apparatus 6. The light combiner 5 is, for example, a cross dichroic prism.

The projection optical apparatus 6 is configured with multiple projection lenses. The projection optical apparatus 6 enlarges the combined image light from the light combiner 5 and projects the enlarged image light toward the screen SCR. A color image is thus displayed on the screen SCR.

The configuration of the first illuminator 20 will be subsequently described.

The first illuminator 20 includes a light source apparatus 30A, an optical integration system 90, a polarization converter 93, and a superimposing system 94.

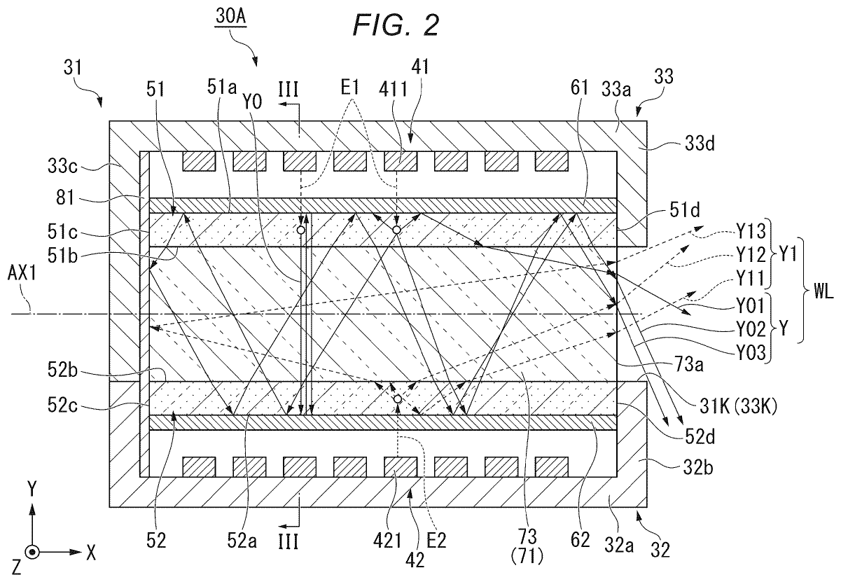

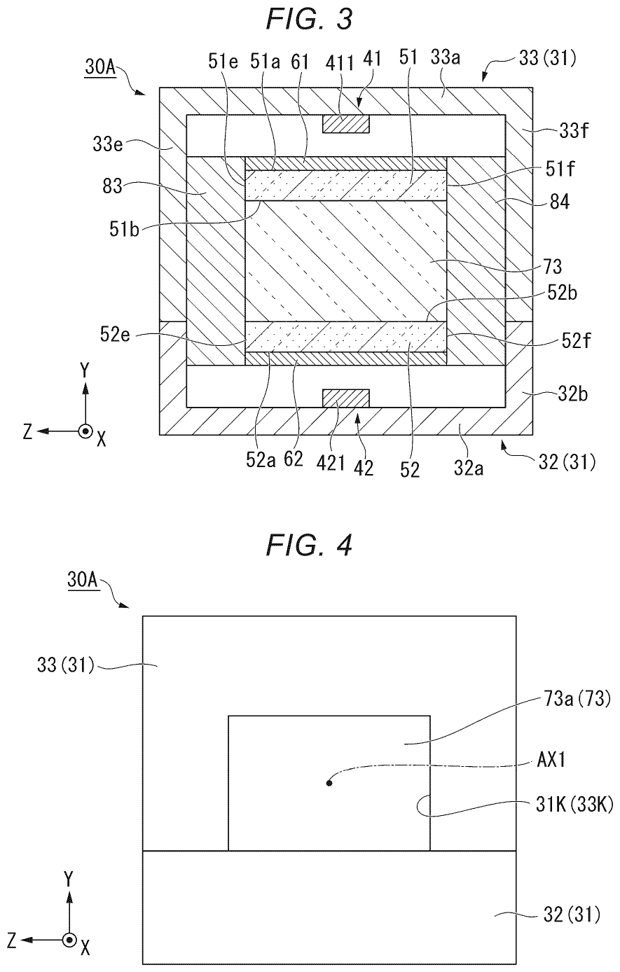

FIG. 2 is a cross-sectional view of the light source apparatus 30A according to the present embodiment. FIG. 3 is a cross-sectional view of the light source apparatus 30A taken along the line III-III in FIG. 2.

The light source apparatus 30A according to the present embodiment includes an enclosure 31, a first light source 41, a first wavelength converter 51, a first optical layer 61, a light guide 71, a second light source 42, a second wavelength converter 52, a second optical layer 62, a first reflection member 81, a third reflection member 83, and a fourth reflection member 84, as shown in FIGS. 2 and 3.

The enclosure 31 constitutes the exterior of the light source apparatus 30A. The enclosure 31 houses the first light source 41, the first optical layer 61, the light guide 71, the first wavelength converter 51, the second light source 42, the second optical layer 62, the second wavelength converter 52, the first reflection member 81, the third reflection member 83, and the fourth reflection member 84. The enclosure 31 is configured with a bottom plate 32 and a lid 33. The lid 33 has a box-like shape having one open surface, and has a top wall 33a, a first sidewall 33c, a second side wall 33d, a third sidewall 33e, a fourth sidewall 33f, and an opening 33k.

The bottom plate 32 is disposed along the XZ plane and has a recess that houses the second light source 42. The bottom plate 32 includes a base 32a and a frame 32b. The base 32a is a plate-shaped member forming the body of the bottom plate 32 and elongated in the X-axis direction. The frame 32b is integrated with the base 32a into a unit, and is provided at the +Y-side surface of the base 32a.

The bottom plate 32 is coupled to the second light source 42 and the second wavelength converter 52 in a heat transferable manner. To this end, it is desirable that the bottom plate 32 is made of a material having predetermined strength and high thermal conductivity. It is therefore desirable to use metal such as aluminum or stainless steel, in particular, an aluminum alloy such as a 6061 aluminum alloy as the material of the bottom plate 32.

As for the lid 33, the top wall 33a is disposed along the XZ plane. The first sidewall 33c and the second sidewall 33d intersect the X-axis the with along longitudinal direction of the light source apparatus 30A and are located on opposite sides in the X-axis direction. The first sidewall 33c is located on the −X side, which is one side in the X-axis direction. The second sidewall 33d is located on the +X side, which is the other side in the X-axis direction. The third sidewall 33e and the fourth sidewall 33f are located on opposite sides in the Z-axis direction, which intersects with the longitudinal direction of the light source apparatus 30A. In the present embodiment, the third sidewall 33e is located on the +Z side, which is one side in the Z-axis direction. The fourth sidewall 33f is located on the −Z side, which is the other side in the Z-axis direction.

The top wall 33a is coupled to the first light source 41 in a heat transferable manner. The third sidewall 33e and the fourth sidewall 33f are coupled to the first wavelength converter 51 and the light guide 71 in a heat transferable manner via the third reflection member 83 and the fourth reflection member 84. To this end, it is desirable that the lid 33 is made of a material having predetermined strength and high thermal conductivity, as the bottom plate 32. It is therefore desirable to use metal such as aluminum or stainless steel, in particular, an aluminum alloy such as a 6061 aluminum alloy as the material of the lid 33, as in the case of the bottom plate.

According to the configuration described above, heat of the first wavelength converter 51, the light guide 71, and the second wavelength converter 52 is dissipated out of the light source apparatus 30A via the lid 33, so that a rise in the temperature of the first wavelength converter 51, the light guide 71, and the second wavelength converter 52 can be suppressed. As a result, a decrease in wavelength conversion efficiency due to the rise in the temperature of the first wavelength converter 51 and the second wavelength converter 52 can be suppressed.

The bottom plate 32 and the lid 33 are so disposed that the sidewalls thereof are in contact with each other. The lid 33 and the bottom plate 32 are fixed to each other via a fixing member such as an adhesive or screws neither of which is shown. As described above, in the light source apparatus 30A, a space surrounded by the enclosure 31 houses the elements of the light source apparatus 30A: the first light source 41; the first optical layer 61; the light guide 71; the first wavelength converter 51; the second light source 42; the second optical layer 62; the second wavelength converter 52; the first reflection member 81; the third reflection member 83; and the fourth reflection member 84. Adhesion of foreign matter such as dust to the elements described above can thus be avoided.

The enclosure 31 has a light extraction port 31K, via which the yellow illumination light WL emitted from the light guide 71 is extracted out of the enclosure 31. The light extraction port 31K is an opening defined by the opening 33K provided in the second sidewall 33d of the lid 33 and a portion of the frame 32b of the bottom plate 32.

FIG. 4 is a plan view of the light source apparatus 30A viewed from the +X side toward the −X side. That is, FIG. 4 is a plan view viewed in the X-axis direction, which is the direction of a normal to a second end surface 51d, which is one end surface of the first wavelength converter 51 and spreads along the YZ plane. The light extraction port 31K overlaps the light guide 71, as shown in FIG. 4. That is, the light extraction port 31K has a shape that covers the first optical layer 61, the first wavelength converter 51, the second wavelength converter 52, and the second optical layer 62 and exposes the light guide 71 in the light extraction port 31K.

The light source apparatus 30A according to the present embodiment can efficiently extract, as the yellow illumination light WL, fluorescence Y and Y1 having propagated through the interior of the light guide 71 via the light extraction port 31K of the enclosure 31.

The light extraction port 31K may have a configuration in which a lid configured with a light transmissive member closes the light extraction port 31K not to expose the light guide 71 to the space outside the enclosure 31.

The first light source 41 includes multiple first light emitters 411. The multiple first light emitters 411 are mounted on the top wall 33a of the enclosure 31. The number of the first light emitters 411 provided in the first light source 41 is not particularly limited to a specific number. The first light emitters 411 each emit an excitation beam having a first wavelength band. The first light emitters 411 are each configured, for example, with a light emitting diode (LED). The first light emitters 411 are disposed so as to face the first wavelength converter 51, and each emit the excitation beam toward the first wavelength converter 51. The first wavelength band is, for example, a violet-to-blue wavelength band ranging from 400 nm to 480 nm and has a center wavelength of, for example, 455 nm. The multiple first light emitters 411 are arranged along the X-axis direction, which is the longitudinal direction of the first wavelength converter 51. The first light source 41 thus emits first excitation light E1 having the first wavelength band and containing multiple blue excitation beams toward the first wavelength converter 51. The first excitation light E1 in the present embodiment corresponds to an example of “first light having a first wavelength band” in the present disclosure.

The first wavelength converter 51 has a columnar shape extending along the X-axis and has six surfaces. Out of the sides of the first wavelength converter 51, the sides extending along the X-axis are longer than the sides extending along the Y-axis and the sides extending along the Z-axis. The X-axis direction corresponds to the longitudinal direction of the first wavelength converter 51. The Y-axis direction is a direction parallel to the shortest sides out of the sides of the first wavelength converter 51. The length of the sides along the Y-axis is shorter than the length of the sides along the Z-axis. That is, the first wavelength converter 51 taken along a plane along the YZ plane has a quadrangular cross-sectional shape, as shown in FIG. 3.

The first wavelength converter 51 has a front surface 51a, a rear surface 51b, a first end surface 51c, a second end surface 51d, a first side surface 51e, and a second side surface 51f. The front surface 51a and the rear surface 51b intersect with the Y-axis and face opposite sides in the Y-axis direction. In the present embodiment, the front surface 51a is a surface located on the +Y side, which is one side in the Y-axis direction. The rear surface 51b is a surface located on the −Y side, which is the other side in the Y-axis direction. The first excitation light E1 is incident on the front surface 51a from the first light source 41 disposed on the top wall 33a via the first optical layer 61 and the light guide 71. The front surface 51a in the present embodiment corresponds to an example of “a first surface” in the present disclosure.

The first end surface 51c and the second end surface 51d intersect with the front surface 51a and the rear surface 51b, and face opposite sides in the X-axis direction along the longitudinal direction of the first wavelength converter 51, as shown in FIG. 2. In the present embodiment, the first end surface 51c is located on the −X side, which is one side in the X-axis direction. The second end surface 51d is located on the +X side, which is the other side in the X-axis direction. The first end surface 51c in the present embodiment corresponds to an example of “a second surface” in the present disclosure, and the second end surface 51d in the present embodiment corresponds to an example of “a third surface” in the present disclosure.

The first side surface 51e and the second side surface 51f intersect with the front surface 51a, the rear surface 51b, the first end surface 51c, and the second end surface 51d, and face opposite sides in the Z-axis direction, as shown in FIG. 3. In the present embodiment, the first side surface 51e is located on the +Z side, which is one side in the Z-axis direction, and the second side surface 51f is located on the −Z side, which is the other side in the Z-axis direction. The first side surface 51e in the present embodiment corresponds to an example of “a fourth surface” in the present disclosure, and the second side surface 51f in the present embodiment corresponds to an example of “a fifth surface” in the present disclosure.

The first wavelength converter 51 contains at least a yellow phosphor, and converts the first excitation light E1 having the first wavelength band and emitted from the first light source 41 into the yellow fluorescence Y having a second wavelength band different from the first wavelength band.

The first excitation light E1 having been emitted from the first light source 41 and having passed through the first optical layer 61 is incident on the front surface 51a of the first wavelength converter 51.

The first wavelength converter 51 contains a ceramic phosphor configured with a polycrystalline phosphor that converts in terms of wavelength the first excitation light E1 into the yellow fluorescence Y. The first wavelength converter 51 in the present embodiment is configured with a phosphor that does not scatter light, what is called a transparent phosphor. The second wavelength band to which the fluorescence Y belongs is a yellow wavelength band ranging, for example, from 490 to 750 nm. The center wavelength of the second wavelength band is, for example, 550 nm. That is, the fluorescence Y is yellow fluorescence containing a red light component and a green light component. The yellow fluorescence Y in the present embodiment corresponds to an example of “second light” in the present disclosure.

In the present specification, the transparent phosphor refers, for example, to a phosphor having a total light transmittance of 80% or higher with respect to fluorescence. The transparent phosphor that constitutes the first wavelength converter 51 may be a transparent single crystal or polycrystal having total light transmittance of 80% or higher, and may, for example, be a YAG-ceramic-based ceramic phosphor produced as a result of sintering multiple YAG phosphor particles.

The first wavelength converter 51 made of the material described above converts the first excitation light E1 into the yellow fluorescence Y.

The first optical layer 61 is disposed between the first light source 41 and the first wavelength converter 51. The first optical layer 61 has an optical characteristic of transmitting the first excitation light E1 and reflecting the fluorescence Y. The first optical layer 61 is configured, for example, with a dielectric multilayer film. The first optical layer 61 is provided on a surface of the first wavelength converter 51 that is the surface facing the first light source 41.

The light guide 71 is disposed between the first optical layer 61 and the first wavelength converter 51. The light guide 71 guides the fluorescence Y and Y1 as a result of conversion performed by the first wavelength converter 51 and the second wavelength converter 52, as will be described later. In the present embodiment, a first light transmissive member 73 is disposed as the light guide 71.

The first light transmissive member 73 is made of a light transmissive material, for example, borosilicate glass such as BK7, quartz, synthetic quartz, quartz crystal, SiC, GaN, MgO, YAG, sapphire, and diamond. As described above, the first light transmissive member 73 needs to be made of a material that can transmit the excitation light E and the fluorescence Y and Y1. The first light transmissive member 73 has a plate-like shape extending along the X-axis. The first light transmissive member 73 taken along the YZ plane has a quadrangular cross-sectional shape and is elongated in the X-axis direction, as shown in FIG. 3.

It is desirable that the thermal conductivity of the first light transmissive member 73 is higher than the thermal conductivity of the first wavelength converter 51 and the second wavelength converter 52. The material of the first light transmissive member 73 that satisfies the condition described above is, for example, SiC, GaN, MgO, YAG, sapphire, or diamond. According to the configuration described above, the heat of the first wavelength converter 51 and the second wavelength converter 52 is efficiently transmitted to the first light transmissive member 73, so that the rise in the temperature of the first wavelength converter 51 and the second wavelength converter 52 can be suppressed. A decrease in conversion efficiency of the first wavelength converter 51 and the second wavelength converter 52 due to the rise in the temperature thereof can thus be suppressed.

The second light source 42 includes multiple second light emitters 421, as shown in FIG. 2. The multiple second light emitters 421 are mounted on the bottom plate 32 of the enclosure 31. Note that the number of the second light emitters 421 is not particularly limited to a specific number. The second light emitters 421 each emit the first excitation beam having the first wavelength band, as the first light emitters 411 of the first light source 41. The multiple second light emitters 421 are arranged along the X-axis direction, which is the longitudinal direction of the second wavelength converter 52.

The second light source 42 is disposed on the side (−Y side) opposite the light guide 71 with the second wavelength converter 52, which will be described later, disposed therebetween. Based on the configuration described above, the second light source 42 emits second excitation light E2, which has the first wavelength band and contains multiple blue excitation beams, toward the second wavelength converter 52. The second excitation light E2 in the present embodiment corresponds to an example of “first light having a first wavelength band” in the present disclosure.

The second wavelength converter 52 is disposed on the −Y side of the first wavelength converter 51. That is, the second wavelength converter 52 is disposed on the side opposite the first wavelength converter 51 with the light guide 71 disposed therebetween.

The second wavelength converter 52 has a columnar shape extending along the X-axis and has six surfaces. Out of the sides of the second wavelength converter 52, the sides extending along the X-axis are longer than the sides extending along the Y-axis and the sides extending along the Z-axis. The X-axis direction corresponds to the longitudinal direction of the second wavelength converter 52. The Y-axis direction is direction parallel to the shortest sides out of the sides of the second wavelength converter 52. The length of the sides along the Y-axis is shorter than the length of the sides along the Z-axis. That is, the second wavelength converter 52 taken along a plane along the YZ plane has a quadrangular cross-sectional shape, as shown in FIG. 3.

The second wavelength converter 52 has a front surface 52a, a rear surface 52b, a first end surface 52c, a second end surface 52d, a first side surface 52e, and a second side surface 52f. The front surface 52a and the rear surface 52b intersect with the Y-axis and face opposite sides in the Y-axis direction. In the present embodiment, the front surface 52a is a surface located on the −Y side, which is one side in the Y-axis direction. The rear surface 52b is a surface located on the +Y side, which is the other side in the Y-axis direction.

The first end surface 52c and the second end surface 52d intersect with the front surface 52a and the rear surface 52b, and face opposite sides in the X-axis direction along the longitudinal direction of the second wavelength converter 52, as shown in FIG. 2. In the present embodiment, the first end surface 52c is located on the −X side, which is one side in the X-axis direction. The second end surface 52d is located on the +X side, which is the other side in the X-axis direction.

The first side surface 52e and the second side surface 52f intersect with the front surface 52a, the rear surface 52b, the first end surface 52c, and the second end surface 52d, and face opposite sides in the Z-axis direction, as shown in FIG. 3. In the present embodiment, the first side surface 52e is located on the +Z side, which is one side in the Z-axis direction, and the second side surface 52f is located on the −Z side, which is the other side in the Z-axis direction.

The second wavelength converter 52 converts the first excitation light E1 having been emitted from the first light source 41 and having passed through the first optical layer 61, the first wavelength converter 51, and the light guide 71, and the second excitation light E2 having been emitted from the second light source 42 and having passed through the second optical layer 62 into the yellow fluorescence Y1 having a third wavelength band different from the first wavelength band. The first excitation light E1 is incident on the rear surface 52b of the second wavelength converter 52, and the second excitation light E2 is incident on the front surface 52a of the second wavelength converter 52.

In the present embodiment, the second wavelength converter 52 is made of the same material as the first wavelength converter 51. Therefore, the third wavelength band, to which the fluorescence Y1 belongs, is, for example, the yellow wavelength band ranging from 490 to 750 nm, and the center wavelength of the third wavelength band is 550 nm, which is equal to the center wavelength of the second wavelength band. The yellow fluorescence Y1 in the present embodiment corresponds to an example of “third light” in the present disclosure.

Note that the second wavelength band and the third wavelength band may differ from each other, and that for example, the center wavelength of the second wavelength band may be a wavelength relatively close to the blue region, and the center wavelength of the third wavelength band may be a wavelength relatively close to the green region.

The second optical layer 62 is disposed between the second light source 42 and the second wavelength converter 52. The second optical layer 62 is disposed on the side opposite the light guide 71 with the second wavelength converter 52 disposed therebetween, and has an optical characteristic of transmitting the second excitation light E2 and reflecting the fluorescence Y and Y1. The second optical layer 62 is configured, for example, with a dielectric multilayer film. The second optical layer 62 is provided on a surface of the second wavelength converter 52 that is the surface facing the second light source 42.

The first reflection member 81 is disposed on the −X side of the first light source 41, the first optical layer 61, the light guide 71, the first wavelength converter 51, the second wavelength converter 52, the second optical layer 62, and the second light source 42, as shown in FIG. 2. That is, the first reflection member 81 is disposed in a region at the side of the first end surface 51c of the light guide 71. The first reflection member 81 is disposed at a portion of the first sidewall 33c of the lid 33 and the frame 32b of the bottom plate 32. Note that the first reflection member 81 is not necessarily provided across the region described above, and may be provided at least in a region at the side of the first end surface 51c of the light guide 71.

The first reflection member 81 reflects the fluorescence Y and Y1 having propagated through the interiors of the light guide 71, the first wavelength converter 51, and the second wavelength converter 52 and having reached the first reflection member 81. The first reflection member 81 further reflects the first excitation light E1, the second excitation light E2, and the fluorescence Y and Y1 having propagated through the first wavelength converter 51, the second wavelength converter 52, or the light guide 71 and having reached the first reflection member 81. That is, the first reflection member 81 reflects the fluorescence Y and Y1, the first excitation light E1, and the second excitation light E2. The first reflection member 81 is configured, for example, with a metal film, a dielectric multilayer film, or a scattering member containing barium sulfate.

The third reflection member 83 is disposed at the third sidewall 33e of the enclosure 31 so as to face the first side surface 51e of the first wavelength converter 51, a region of the light guide 71, at the side of the first side surface 51e, and the first side surface 52e of the second wavelength converter 52, as shown in FIG. 3.

The fourth reflection member 84 is disposed at the fourth sidewall 33f of the enclosure 31 so as to face the second side surface 51f of the first wavelength converter 51, a region of the light guide 71, at the side of the second side surface 51f, and the second side surface 52f of the second wavelength converter 52.

The third reflection member 83 reflects the fluorescence Y and Y1, the first excitation light E1, and the second excitation light E2. Therefore, for example, the third reflection member 83 reflects the first excitation light E1 having passed through the first wavelength converter 51 and the light guide 71 and having reached the third reflection member 83, and causes the reflected first excitation light E1 to enter the first wavelength converter 51. The efficiency at which the first excitation light E1 is converted into the fluorescence Y can thus be increased. The third reflection member 83 further reflects the second excitation light E2 having passed through the second wavelength converter 52 and the light guide 71 and having reached the third reflection member 83, and causes the reflected second excitation light E2 to enter the second wavelength converter 52. The efficiency at which the second excitation light E2 is converted into the fluorescence Y1 can thus be increased.

Furthermore, the third reflection member 83 reflects the fluorescence Y having been emitted from the first wavelength converter 51, having entered the light guide 71, and having reached the third reflection member 83, and the fluorescence Y having been guided through the interior of the first wavelength converter 51 and having reached the third reflection member 83. Loss of the fluorescence Y can thus be suppressed. The third reflection member 83 further reflects the fluorescence Y1 having been emitted from the second wavelength converter 52, having entered the light guide 71, and having reached the third reflection member 83, and the fluorescence Y1 having been guided through the interior of the second wavelength converter 52 and having reached the third reflection member 83. Loss of the fluorescence Y1 can thus be suppressed.

Similarly, the fourth reflection member 84 reflects the fluorescence Y and Y1, the first excitation light E1, and the second excitation light E2. The effects and advantages of the fourth reflection member 84 are the same as the aforementioned effects and advantages of the third reflection member 83. The third reflection member 83 and the fourth reflection member 84 are each configured, for example, with a metal film, a dielectric multilayer film, or a scattering member.

The optical integration system 90 is provided on the light exiting side of the light source apparatus 30A, as shown in FIG. 1. The optical integration system 90 includes a first lens array 91 and a second lens array 92. The optical integration system 90 cooperates with the superimposing system 94 to function as a homogeneous illumination system that homogenizes the intensity distribution of the illumination light WL emitted from the light source apparatus 30A at each of the light modulators 4R, 4G, and 4B, which are each an illumination receiving region.

The first lens array 91 includes multiple first lenses 91a. The multiple first lenses 91a is arranged in a matrix in a plane parallel to the YZ plane perpendicular to the optical axis AX1 of the first illuminator 20. The multiple first lenses 91a divide the white light WL emitted from the light source apparatus 30A into multiple sub-luminous fluxes. The first lenses 91a each have a rectangular shape substantially similar to the shape of the image formation region of each of the light modulators 4R, 4G, and 4B. The sub-luminous fluxes emitted from the first lens array 91 are therefore efficiently incident on the image formation region of each of the light modulators 4R, 4G, and 4B.

The illumination light WL emitted from the first lens array 91 travels toward the second lens array 92. The second lens array 92 is disposed so as to face the first lens array 91. The second lens array 92 includes multiple second lenses 92a corresponding to the multiple first lenses 91a of the first lens array 91. The second lens array 92 cooperates with the superimposing system 94 to form images of the multiple first lenses 91a of the first lens array 91 in the vicinity of the image formation region of each of the light modulators 4R, 4G, and 4B. The multiple second lenses 92a are arranged in a matrix in a plane parallel to the YZ plane perpendicular to the optical axis AX1 of the first illuminator 20. The superimposing system 94 is configured with a single convex lens.

In the present embodiment, the first lenses 91a of the first lens array 91 and the second lenses 92a of the second lens array 92 have the same size, but may have sizes different from each other. Furthermore, in the present embodiment, the first lenses 91a of the first lens array 91 and the second lenses 92a of the second lens array 92 are disposed at positions where the optical axes thereof coincide with each other, but may be disposed with the optical axes thereof shifted from each other.

The polarization converter 93 converts the polarization direction of the illumination light WL emitted from the second lens array 92. Specifically, the polarization converter 93 converts each of the sub-luminous fluxes into which the illumination light WL is divided by the first lens array 91 and which are emitted from the second lens array 92 into linearly polarized light. The polarization converter 93 includes polarization separation layers, reflection layers, and phase retardation layers none of which is shown. The polarization separation layers transmit one linearly polarized component of the polarized components contained in the illumination light WL emitted from the light source apparatus 30A with no change in the state of the one linearly polarized component, and reflects the other linearly polarized component in a direction perpendicular to the optical axis AX1. The reflection layers reflect the other linearly polarized component reflected off the polarization separation layers in a direction parallel to the optical axis AX1. The phase retardation layers convert the other linearly polarized component reflected off the reflection layers into the one linearly polarized component.

The behavior of the light in the light source apparatus 30A according to the present embodiment will be described below.

In the light source apparatus 30A, the first excitation light E1 emitted from the first light source 41 passes through the first optical layer 61 and enters the first wavelength converter 51, as shown in FIG. 2.

When the first excitation light E1 enters the first wavelength converter 51, the phosphor contained in the first wavelength converter 51 is excited by the first excitation light E1, and the fluorescence Y is emitted from arbitrary light emission points in various directions.

Fluorescence Y01 emitted from the first wavelength converter 51 is reflected off the first optical layer 61, enters the first light transmissive member 73, and exits out of the light source apparatus 30A via an end surface 73a of the first light transmissive member 73, at the side of the second end surface 51d. Fluorescence Y02 emitted from the first wavelength converter 51 passes through the first light transmissive member 73 and the second wavelength converter 52, is reflected off the second optical layer 62, passes through the first light transmissive member 73 and the first wavelength converter 51, is reflected off the first optical layer 61 again, enters the first light transmissive member 73, and exits out of the light source apparatus 30A via the end surface 73a of the first light transmissive member 73, at the side of the second end surface 51d. Although not shown, part of the fluorescence Y having entered the first light transmissive member 73 is reflected off the rear surface 52b of the second wavelength converter 52, enters the first light transmissive member 73 again, and exits out of the light source apparatus 30A via the end surface 73a of the first light transmissive member 73, at the side of the second end surface 51d.

Fluorescence Y03 having been emitted from the first wavelength converter 51 and having reached the first reflection member 81 is reflected off the first reflection member 81, then travels toward the +X side, is reflected, for example, off the first optical layer 61 and the second optical layer 62 to propagate through the interior of the first light transmissive member 73, and exits out of the light source apparatus 30A via the end surface 73a of the first light transmissive member 73.

The fluorescence Y emitted from the first wavelength converter 51 propagates through the interior of the first light transmissive member 73 while repeatedly reflected off the first wavelength converter 51 or the first optical layer 61 and the second wavelength converter 52 or the second optical layer 62 in the space therebetween, and exits out of the light source apparatus 30A via the end surface 73a of the first light transmissive member 73, at the side of the second end surface 51d. The end surface 73a of the first light transmissive member 73, at the side of the second end surface 51d, in the present embodiment corresponds to an example of “a region of the light guide, at the side of the third surface” and “an end surface of the first light transmissive member, at the side of the third surface” in the present disclosure.

The second excitation light E2 emitted from the second light source 42 passes through the second optical layer 62 and enters the second wavelength converter 52. When the second excitation light E2 enters the second wavelength converter 52, the phosphor contained in the second wavelength converter 52 is excited by the second excitation light E2, and the fluorescence Y1 is emitted from arbitrary light emission points. Note that the fluorescence Y1 behaves in the same manner as the fluorescence Y.

For example, fluorescence Y11 emitted from the second wavelength converter 52 is reflected off the second optical layer 62, enters the first light transmissive member 73, and exits out of the light source apparatus 30A via the end surface 73a of the first light transmissive member 73, at the side of the second end surface 51d. Fluorescence Y12 emitted from the second wavelength converter 52 directly enters the first light transmissive member 73, and exits out of the light source apparatus 30A via the end surface 73a of the first light transmissive member 73, at the side of the second end surface 51d. Fluorescence Y13 having been emitted from the second wavelength converter 52 and having reached the first reflection member 81 is reflected off the first reflection member 81, then travels through the interior of the first light transmissive member 73 toward the +X side, and exits out of the light source apparatus 30A via the end surface 73a of the first light transmissive member 73.

The fluorescence Y1 emitted from the second wavelength converter 52 propagates through the interior of the first light transmissive member 73 while repeatedly reflected off the first wavelength converter 51 or the first optical layer 61 and the second wavelength converter 52 or the second optical layer 62 in the space therebetween, and exits out of the light source apparatus 30A via the end surface 73a of the first light transmissive member 73, at the side of the second end surface 51d.

Therefore, in the light source apparatus 30A according to the present embodiment, the fluorescence Y as a result of conversion performed by the first wavelength converter 51, and the fluorescence Y1 as a result of conversion performed by the second wavelength converter 52 travel through the light guide 71 and exits via the end surface 73a of the first light transmissive member 73. The light source apparatus 30A according to the present embodiment therefore allows the illumination light WL containing the fluorescence Y and Y1 to be efficiently extracted out of the enclosure 31 via the light extraction port 31K thereof.

Note in the present embodiment that since the first wavelength converter 51 and the second wavelength converter 52 are each configured with a transparent phosphor, the traveling direction of fluorescence Y0 incident on the first optical layer 61 in the direction of a normal thereto and reflected perpendicularly off the first optical layer 61 out of the fluorescence Y emitted from the first wavelength converter 51 is unlikely to change while passing through the interior of the first wavelength converter 51 and the second wavelength w converter 52, so that the fluorescence Y0 is repeatedly reflected off the first optical layer 61 and the second optical layer 62 in the space therebetween, as shown in FIG. 2. The same applies to the fluorescence Y1 emitted from the second wavelength converter 52: the fluorescence Y1 incident on the second optical layer 62 in the direction of a normal thereto and reflected perpendicularly off the second optical layer 62 is repeatedly reflected off the first optical layer 61 and the second optical layer 62 in the space therebetween. The fluorescence repeatedly reflected off the first optical layer 61 and the second optical layer 62 in the space therebetween is absorbed and lost while propagating multiple times through the interior of the first wavelength converter 51 and the second wavelength converter 52.

Since the light source apparatus 30A according to the present embodiment causes the illumination light WL to be extracted out of the enclosure 31 via the light extraction port 31K thereof, the etendue of the illumination light WL is small, so that the amount of illumination light WL lost in the optical integration system 90 and other optical members disposed downstream from the light source apparatus 30A can be reduced. As a result, the efficiency at which the illumination light WL is used in the light source apparatus 30A can be improved.

In the light source apparatus 30A according to the present embodiment, the first wavelength converter 51 and the second wavelength converter 52 are disposed so as to sandwich the first light transmissive member 73, as shown in FIG. 2. Now consider as Comparative Example a configuration in which a pair of light transmissive members are disposed so as to sandwich a single wavelength converter, and excitation light enters the wavelength converter via opposite sides of the wavelength converter.

In Comparative Example, the fluorescence generated by the wavelength converter exits via three locations: the ends of the pair of light transmissive members; and the end of the wavelength converter. The amount of the fluorescence propagating through the interior of the wavelength converter and exiting via the end of the wavelength converter is smaller than the amount of the fluorescence propagating through the interior of each of the light transmissive members and exiting via the end of each of the light transmissive members.

In Comparative Example, the illumination light emitted from the pair of light transmissive members and the wavelength converter has a dark central portion corresponding to the wavelength converter, and bright peripheries corresponding to the pair of light transmissive members, so that there is a problem of a decrease in the uniformity of the illuminance distribution. Furthermore, in Comparative Example, part of the excitation light reflected off the surfaces of the light transmissive members returns toward the light source, and is therefore likely to cause a problem of loss of the excitation light.

In contrast, in the light source apparatus 30A according to the present embodiment, only the end surface 73a of the first light transmissive member 73, which forms the light guide 71, is exposed via the light extraction port 31K of the enclosure 31, as shown in FIG. 4. Therefore, since the illumination light WL emitted by the light source apparatus 30A according to the present embodiment is configured with the fluorescence Y and Y1 having propagated through the interior of the first light transmissive member 73, the illuminance distribution of the illumination light WL has excellent uniformity as s compared with that in Comparative Example.

Note in FIG. 4 that the light extraction port 31K is formed so as to cover the first wavelength converter 51 and the second wavelength converter 52, but that the first wavelength converter 51 and the second wavelength converter 52 may be exposed in the light extraction port 31K depending on the application of the illumination light WL, as will be described later.

The configuration in which the first wavelength converter 51 and the second wavelength converter 52 are exposed in the light extraction port 31K as described above allows the fluorescence Y having exited via the +X-side end surface of the first wavelength converter 51 and the fluorescence Y1 having exited via the +X-side end surface of the second wavelength converter 52 to be extracted out of the light source apparatus 30A via the light extraction port 31K as part of the illumination light WL, so that the brightness of the illumination light WL can be further improved. Since the amount of the fluorescence Y that exits via the end surface of the first wavelength converter 51 and the amount of the fluorescence Y1 that exits via the end surface of the second wavelength converter 52 are smaller than the amount of the fluorescence Y that exits via the end surface of the light guide 71 and the amount of the fluorescence Y1 that exits via the end surface of the light guide 71 respectively, the uniformity of the illuminance distribution of the illumination light WL is affected to a certain extent. In contrast, in the light source apparatus 30A according to the present embodiment, since the first wavelength converter 51 and the second wavelength converter 52 are disposed so as to sandwich the light guide 71, the illuminance at the peripheries of the illumination light WL decreases, so that the uniformity of the illuminance distribution is less affected than in the configuration in Comparative Example, in which the illuminance at the central portion of the illumination light significantly decreases.

Therefore, in the light source apparatus 30A according to the present embodiment, when priority is given to the brightness of the illumination light WL, the light extraction port 31K may be so formed that the first wavelength converter 51 and the second wavelength converter 52 are exposed in the light extraction port 31K, whereas when priority is given to the illuminance distribution of the illumination light WL, the light extraction port 31K may be formed so as to cover the first wavelength converter 51 and the second wavelength converter 52.

Furthermore, the light source apparatus 30A according to the present embodiment has the configuration in which the light transmissive member is not disposed between each of the light sources and the corresponding wavelength converter. The excitation light therefore directly enters the wavelength converter, so that the loss due to the reflection of the excitation light at the surfaces of the light transmissive member can be reduced.

### Advantages of First Embodiment

The light source apparatus 30A according to the present embodiment includes the first light source 41, which emits the excitation light E, the first wavelength converter 51, which converts the excitation light E into the yellow fluorescence Y, the first optical layer 61, which is disposed between the first light source 41 and the first wavelength converter 51, transmits the excitation light E, and reflects the yellow fluorescence Y, the light guide 71, which is disposed on the side opposite the first optical layer 61 with the first wavelength converter 51 disposed therebetween and guides the incident light, the second wavelength converter 52, which is disposed on the side opposite the first wavelength converter 51 with the light guide 71 disposed therebetween and converts the excitation light E incident via the first optical layer 61, the first wavelength converter 51, and the light guide 71 into the yellow fluorescence Y1, the second optical layer 62, which is disposed on the side opposite the light guide 71 with the second wavelength converter 52 disposed therebetween and reflects the fluorescence Y and the fluorescence Y1, and the first reflection member 81, which reflects the excitation light E, the fluorescence Y, and the fluorescence Y1. The first wavelength converter 51 has the front surface 51a, on which the excitation light E is incident via the first optical layer 61, and the first end surface 51c and the second end surface 51d, which intersect with the front surface 51a and face opposite sides of each other. The first reflection member 81 is disposed in a region of the light guide 71, at the side of the first end surface 51c. The fluorescence Y as a result of conversion performed by the first wavelength converter 51 and the fluorescence Y1 as a result of conversion performed by the second wavelength converter 52 travel through the light guide 71 and exit via a region of the light guide 71, at the side of the second end surface 51d.

As described above, the light source apparatus 30A according to the present embodiment causes the fluorescence Y generated by the first wavelength converter 51 and the fluorescence Y1 generated by the second wavelength converter 52 to travel through the light guide 71 and exit via the end surface 73a of the first light transmissive member 73, which is a region of the light guide 71, at the side of the second end surface 51d. Loss of the fluorescence Y and Y1 is therefore smaller than that caused by the related-art light source apparatus that causes the fluorescence to propagate through the interior of the wavelength converter with the aid of total reflection and the fluorescence to be extracted, so that the efficiency at which the fluorescence Y and Y1 are used can be increased.

The projector 1 according to the present embodiment includes the light source apparatus 30A, the light modulators 4R, 4G, and 4B, which modulate the light emitted from the light source apparatus 30A, and the projection optical apparatus 6, which projects the light modulated by the light modulators 4R, 4G, and 4B.

The projector 1 according to the present embodiment, which includes the first illuminator 20 including the light source apparatus 30A, which can efficiently extract the illumination light WL containing the fluorescence Y and Y1, excels in light use efficiency.

### Second Embodiment

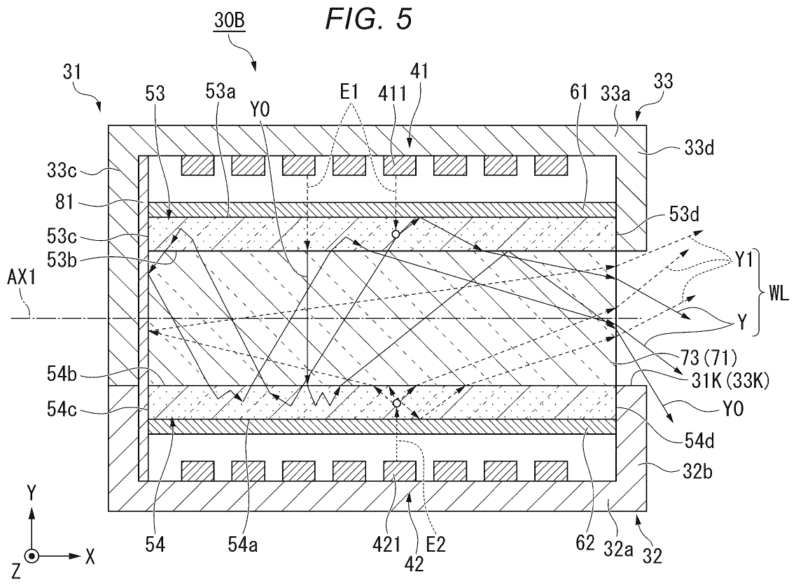

A second embodiment of the present disclosure will be described below with reference to FIG. 5.

The basic configuration of a light source apparatus according to the second embodiment is the same as that in the first embodiment, and the description of the basic configuration of the light source apparatus is therefore omitted.

FIG. 5 is a cross-sectional view of a light source apparatus 30B according to the second embodiment taken along the XY plane. In FIG. 5, elements common to those in the drawings used in the first embodiment have the same reference characters and will not be described.

The light source apparatus 30B according to the present embodiment includes the enclosure 31, the first light source 41, a first wavelength converter 53, the first optical layer 61, the light guide 71, the second light source 42, a second wavelength converter 54, the second optical layer 62, the first reflection member 81, a third reflection member (not shown), and a fourth reflection member (not shown), as shown in FIG. 5.

In the light source apparatus 30A according to the first embodiment, the first wavelength converter 51 and the second wavelength converter 52 are each configured with a transparent phosphor. In contrast, in the light source apparatus 30B according to the present embodiment, the first wavelength converter 53 and the second wavelength converter 54 are each configured with a phosphor that scatters light. The phosphor that scatters light can be realized by dispersing a medium having a refractive index different from that of the transparent phosphor, for example, scatterers such as pores or fillers, in the transparent phosphor. The first wavelength converter 53 has a front surface 53a, a rear surface 53b, a first end surface 53c, and a second end surface 53d. The second wavelength converter 54 has a front surface 54a, a rear surface 54b, a first end surface 54c, and a second end surface 54d.

The other configurations of the light source apparatus 30B are the same as those of the light source apparatus 30A according to the first embodiment.

### Advantages of Second Embodiment

The present embodiment also provides advantages that are the same as those provided by the first embodiment, that is, the light source apparatus 30B allows the fluorescence Y and Y1 to propagate through the light guide 71 so that loss of the fluorescence Y and Y1 is small and the fluorescence Y and Y1 are used at excellent efficiency, and the light source apparatus 30B can efficiently emit the illumination light WL.

In the first embodiment, since the first wavelength converter 51 and the second wavelength converter 52 are each configured with a transparent phosphor, the traveling direction of the fluorescence Y0 (see FIG. 2) perpendicularly incident on the first optical layer 61 out of the fluorescence Y emitted from the first wavelength converter 51 is unlikely to change in the first wavelength converter 51 and the second wavelength converter 52, so that the fluorescence Y0 is repeatedly reflected off the first optical layer 61 and the second optical layer 62 in the space therebetween, resulting in loss of the fluorescence Y. The same applies to the fluorescence Y1 emitted from the second wavelength converter 52.

In contrast, in the present embodiment, since the first wavelength converter 53 and the second wavelength converter 54 are each configured with a phosphor that scatters light, a large amount of scattering occurs when the fluorescence Y emitted from the first wavelength converter 53 enters the second wavelength converter 54 as shown in FIG. 5, and the traveling direction of the fluorescence Y changes whenever the fluorescence Y is scattered. Similarly, since the second wavelength converter 54 is configured with a phosphor that scatters light, a large amount of scattering occurs when the fluorescence Y1 enters the second wavelength converter 54, and the traveling direction of the fluorescence Y1 changes whenever the fluorescence Y1 is scattered.

Therefore, for example, even the fluorescence Y0 perpendicularly incident on the second wavelength converter 54 is scattered and converted in terms of angle by the second wavelength converter 54, and eventually exits via the end surface 73a of the first light transmissive member 73. Furthermore, the fluorescence emitted from the second wavelength converter 54 and entering the first wavelength converter 53 in the direction perpendicular thereto is also scattered and converted in terms of angle by the first wavelength converter 53, and hence eventually exits via the end surface 73a of the first light transmissive member 73. The fluorescence Y and Y1 thus exits via the end surface 73a of the first light transmissive member 73 while repeatedly undergoing at least one of scattering in the first wavelength converter 53, reflection at the first optical layer 61, scattering in the second wavelength converter 54, and reflection at the second optical layer 62.

In the present embodiment, the fluorescence Y and Y1 propagate through the interior of the first wavelength converter 53 and the second wavelength converter 54, so there is substantially no fluorescence Y and Y1 that does not exit out of the light source apparatus 30B. The light source apparatus 30B according to the present embodiment can therefore more efficiently extract the fluorescence Y and Y1 as the illumination light WL.

### Third Embodiment

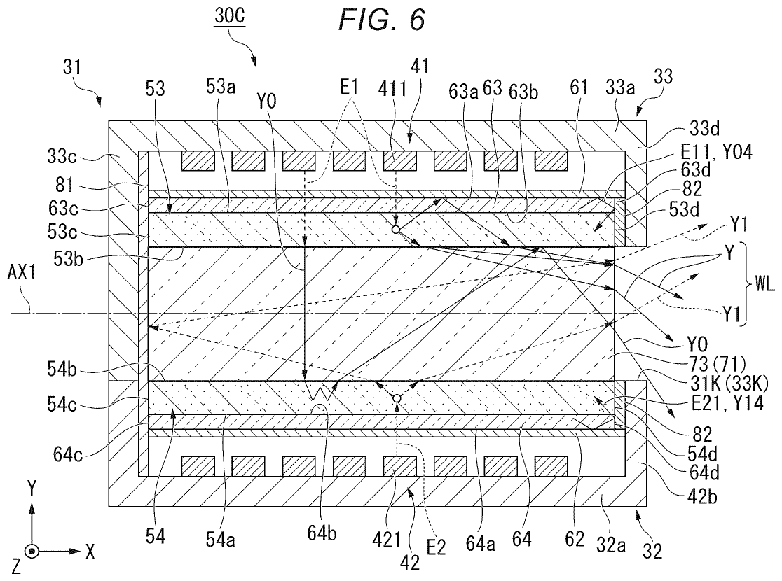

A third embodiment of the present disclosure will be described below with reference to FIG. 6.

The basic configuration of a light source apparatus according to the third embodiment is the same as that in the second embodiment, and the description of the basic configuration of the light source apparatus is therefore omitted.

FIG. 6 is a cross-sectional view of a light source apparatus 30C according to the third embodiment taken along the XY plane. In FIG. 6, elements common to those in the drawings used in the second embodiment have the same reference characters and will not be described.

The light source apparatus 30C according to the present embodiment includes the enclosure 31, the first light source 41, the first wavelength converter 53, the first optical layer 61, a second light transmissive member 63, the light guide 71, the second light source 42, the second wavelength converter 54, the second optical layer 62, a third light transmissive member 64, the first reflection member 81, a second reflection member 82, a third reflection member (not shown), and a fourth reflection member (not shown), as shown in FIG. 6.

In the light source apparatus 30B according to the second embodiment, the first optical layer 61 is provided at the front surface 53a of the first wavelength converter 53, and the second optical layer 62 is provided at the front surface 54a of the second wavelength converter 54. In contrast, in the light source apparatus 30C according to the present embodiment, the second light transmissive member 63 is disposed between the first optical layer 61 and the first wavelength converter 53, and the third light transmissive member 64 is disposed between the second optical layer 62 and the second wavelength converter 54.

The second light transmissive member 63 and the third light transmissive member 64 may each be configured with a plate-shaped light transmissive member, as the first light transmissive member 73. The second light transmissive member 63 and the third light transmissive member 64 may instead be configured, for example, with a transparent layer that is transparent and has smooth surfaces by applying a material such as polysilazane or permeate onto each of the wavelength converters 53 and 54 and then curing the material.

The second light transmissive member 63 has a front surface 63a, a rear surface 63b, a first end surface 63c, a second end surface 63d, a first side surface (not shown), and a second side surface (not shown). The front surface 63a and the rear surface 63b intersect with the Y-axis and face opposite sides in the Y-axis direction. The first end surface 63c and the second end surface 63d intersect with the front surface 63a and the rear surface 63b and face opposite sides in the X-axis direction along the longitudinal direction of the second light transmissive member 63.

The third light transmissive member 64 has a front surface 64a, a rear surface 64b, a first end surface 64c, a second end surface 64d, a first side surface (not shown), and a second side surface (not shown). The front surface 64a and the rear surface 64b intersect with the Y-axis and face opposite sides in the Y-axis direction. The first end surface 64c and the second end surface 64d intersect with the front surface 64a and the rear surface 64b and face opposite sides in the X-axis direction along the longitudinal direction of the third light transmissive member 64.

Also in the present embodiment, the light extraction port 31K overlaps the light guide 71. That is, the light extraction port 31K has a shape that covers the first optical layer 61, the first wavelength converter 51, the second wavelength converter 52, and the second optical layer 62 and exposes the light guide 71 in the light extraction port 31K.

The second reflection member 82 reflects the first excitation light E1, the fluorescence Y, the second excitation light E2, and the fluorescence Y1. The second reflection member 82 is disposed between the enclosure 31 and the second end surface 53d of the first wavelength converter 53 and between the enclosure 31 and the second end surface 63d of the second light transmissive member 63. The second reflection member 82 is configured, for example, with a metal film or a dielectric multilayer film. The second end surface 63d in the present embodiment corresponds to an example of “an end surface of a second light transmissive member, at the side of a third surface” in the present disclosure.

The other configurations of the light source apparatus 30C are the same as those of the light source apparatus 30B according to the second embodiment.

### Advantages of Third Embodiment

The present embodiment also provides advantages that are the same as those provided by the first embodiment, that is, the light source apparatus 30C allows the fluorescence Y and Y1 to propagate through the light guide 71 so that loss of the fluorescence Y and Y1 is small and the fluorescence Y and Y1 are used at excellent efficiency, and the light source apparatus 30C can efficiently emit the illumination light WL.

The first wavelength converter 53 and the second wavelength converter 54 each configured with a phosphor that scatters light and provided with an uneven structure have low-planarity front surfaces 53a and 54a. Therefore, when the first optical layer 61 and the second optical layer 62 are directly formed at the first wavelength converter 53 and the second wavelength converter 54 respectively, the planarity of the first optical layer 61 and the second optical layer 62 may decrease, and the optical characteristics thereof may therefore deteriorate.

In contrast, in the light source apparatus 30C according to the present embodiment, forming the first optical layer 61 and the second optical layer 62 at the second light transmissive member 63 and the third light transmissive member 64 respectively allows formation of each of the first optical layer 61 and the second optical layer 62 with a planar film, so that the optical characteristics of the first optical layer 61 and the second optical layer 62 can be improved.

Therefore, in the light source apparatus 30C according to the present embodiment, the first optical layer 61 and the second optical layer 62 having excellent optical characteristics can be formed even when the first wavelength converter 53 and the second wavelength converter 54 are each configured with a phosphor that scatters light.

In the light source apparatus 30C according to the present embodiment, the heat generated by the first wavelength converter 53 is efficiently dissipated via the second light transmissive member 63, and heat of the second wavelength converter 54 is efficiently dissipated via the third light transmissive member 64. The performance of cooling the first wavelength converter 53 and the second wavelength converter 54 is therefore improved, and the fluorescence conversion efficiency of the first wavelength converter 53 and the second wavelength converter 54 is therefore improved, so that bright fluorescence Y and Y1 can be generated.

In the light source apparatus 30C according to the present embodiment, fluorescence Y04 or excitation light E11 scattered in the first wavelength converter 53 propagates through the interior of the second light transmissive member 63. In the thus configured light source apparatus 30C according to the present embodiment, the fluorescence Y04 or the excitation light E11 having propagated toward the +X side in the second light transmissive member 63 is reflected off the second reflection member 82 and allowed to enter the first wavelength converter 53. The excitation light E11 having entered the first wavelength converter 53 is used to excite the phosphor, and the fluorescence Y04 having entered the first wavelength converter 53 is scattered, exits to the light guide 71, and eventually exits out of the light guide 71. Therefore, in the light source apparatus 30C according to the present embodiment, the fluorescence Y04 and the excitation light E11 propagating through the interior of the second light transmissive member 63 can be extracted from the second light transmissive member 63 and efficiently used.

In the light source apparatus 30C according to the present embodiment, fluorescence Y14 or excitation light E21 scattered in the second wavelength converter 54 propagates through the interior of the third light transmissive member 64. In the thus configured light source apparatus 30C according to the present embodiment, the fluorescence Y14 or the excitation light E21 having propagated toward the +X side in the third light transmissive member 64 is reflected off the second reflection member 82 and allowed to enter the second wavelength converter 54. The excitation light E21 having entered the second wavelength converter 54 is used to excite the phosphor, and the fluorescence Y14 having entered the second wavelength converter 54 is scattered, exits to the light guide 71, and eventually exits out of the light guide 71. Therefore, in the light source apparatus 30C according to the present embodiment, the fluorescence Y14 and the excitation light E21 propagating through the interior of the third light transmissive member 64 can be extracted from the third light transmissive member 64 and efficiently used.

Note that the configuration of the light source apparatus 30C according to the present embodiment is also applicable to the light source apparatus 30A according to the first embodiment. That is, in the light source apparatus 30A according to the first embodiment, the second light transmissive member 63 may be disposed between the first optical layer 61 and the first wavelength converter 51, and the third light transmissive member 64 may be disposed between the second optical layer 62 and the second wavelength converter 52.

The configuration described above, in which the heat of the first wavelength converter 51 is efficiently dissipated via the second light transmissive member 63 and heat of the second wavelength converter 52 is efficiently dissipated via the third light transmissive member 64, can improve the fluorescence conversion efficiency of the first wavelength converter 51 and the second wavelength converter 52 and generate bright fluorescence Y and Y1.

### Fourth Embodiment

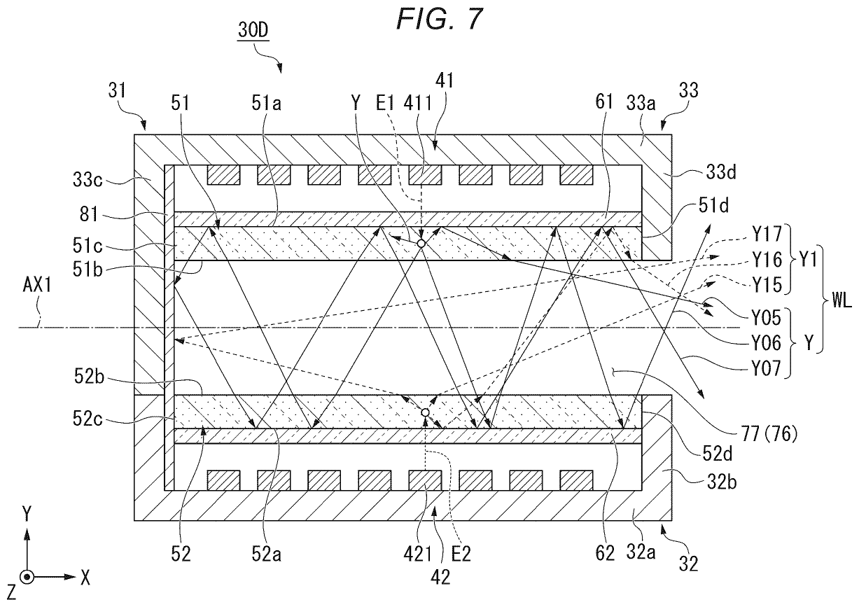

A fourth embodiment of the present disclosure will be described below with reference to FIG. 7.

The basic configuration of a light source apparatus according to the fourth embodiment is the same as that in the first embodiment, and the description of the basic configuration of the light source apparatus is therefore omitted.

FIG. 7 is a cross-sectional view of a light source apparatus 30D according to the fourth embodiment taken along the XY plane. In FIG. 7, the elements common to those in the drawings used in the first embodiment have the same reference characters and will not be described.

The light source apparatus 30D according to the present embodiment includes the enclosure 31, the first light source 41, the first wavelength converter 51, the first optical layer 61, a light guide 76, the second light source 42, the second wavelength converter 52, the second optical layer 62, the first reflection member 81, a third reflection member (not shown), and a fourth reflection member (not shown), as shown in FIG. 7.

The light guide 76 includes an air layer 77. That is, the first wavelength converter 51 and the second wavelength converter 52 are disposed so as to be separate from each other, and air is present between the first wavelength converter 51 and the second wavelength converter 52. The light guide 76 guides the fluorescence Y as a result of conversion performed by the first wavelength converter 51, and the fluorescence Y1 as a result of conversion performed by the second wavelength converter 52. The second wavelength converter 52 is disposed at the side opposite the first light source 41 with the first wavelength converter 51 disposed therebetween. The first reflection member 81 is disposed in a region of the light guide 76, at the side of the first end surface 51c.

In the plan view viewed in the X-axis direction, which is the direction of a normal to the second end surface 51d of the first wavelength converter 51, the light extraction port 31K overlaps the light guide 76. That is, the light extraction port 31K has a shape that covers the first optical layer 61, the first wavelength converter 51, the second wavelength converter 52, and the second optical layer 62 and exposes the light guide 76 in the light extraction port 31K. A region of the light guide 76, at the side of the second end surface 51d is therefore exposed to the outside space via the light extraction port 31K.

The other configurations of the light source apparatus 30D are the same as those of the light source apparatus 30A according to the first embodiment.

The behavior of the light in the light source apparatus 30D according to the present embodiment will be described below.

In the light source apparatus 30D, the first excitation light E1 emitted from the first light source 41 passes through the first optical layer 61 and enters the first wavelength converter 51, as shown in FIG. 7.

When the first excitation light E1 enters the first wavelength converter 51, the phosphor contained in the first wavelength converter 51 is excited by the first excitation light E1, and the fluorescence Y is emitted from arbitrary light emission points in various directions.

Fluorescence Y05 incident on the rear surface 51b of the first wavelength converter 51 at angles of incidence smaller than the critical angle exits out of the first wavelength converter 51 and travels through the air layer 77, and then exits out of a region of the air layer 77, at the side of the second end surface 51d.

Note that the fluorescence Y incident on the rear surface 51b of the first wavelength converter 51 at angles of incidence greater than or equal to the critical angle travels in directions that do not change when passing through the first wavelength converter 51 configured with a transparent phosphor, so that part of the fluorescence Y is absorbed by the phosphor and lost while repeatedly totally reflected off the rear surface 51b of the first wavelength converter 51 and reflected off the first optical layer 61 and the first reflection member 81, and propagating through the interior of the first wavelength converter 51.

Fluorescence Y06 emitted from the first wavelength converter 51, traveling through the air layer 77 toward the +X side, and entering the second wavelength converter 52 travels through the air layer 77 while repeatedly reflected off the second optical layer 62 and the first optical layer 61, and then exits out of the region of the air layer 77, at a side of the second end surface 51d.

Fluorescence Y07 emitted from the first wavelength converter 51, traveling through the air layer 77 toward the −X side, and entering the second wavelength converter 52 travels through the air layer 77 while repeatedly reflected off the second optical layer 62 and the first optical layer 61 is then reflected off the first reflection member 81, travels through the air layer 77 while repeatedly reflected off the second optical layer 62 and the first optical layer 61 again, and then exits out of the region of the air layer 77, at a side of the second end surface 51d.

The second excitation light E2 emitted from the second light source 42 passes through the second optical layer 62 and enters the second wavelength converter 52. When the second excitation light E2 enters the second wavelength converter 52, the phosphor contained in the second wavelength converter 52 is excited by the second excitation light E2, and the fluorescence Y1 is emitted from arbitrary light emission points.

Fluorescence Y15 incident on the rear surface 52b of the second wavelength converter 52 at angles of incidence smaller than the critical angle exits out of the second wavelength converter 52 and travels through the air layer 77, and then exits out of the region of the air layer 77, at a side of the second end surface 51d.

Note that the fluorescence Y15 incident on the rear surface 52b of the second wavelength converter 52 at angles of incidence greater than or equal to the critical angle travels in directions that do not change when passing through the second wavelength converter 52 configured with a transparent phosphor, so that part of the fluorescence Y15 is absorbed by the phosphor and lost while repeatedly totally reflected off the rear surface 52b of the second wavelength converter 52 and reflected off the second optical layer 62 and the first reflection member 81 and, propagating through the interior of the second wavelength converter 52.

Fluorescence Y16 emitted from the second wavelength converter 52, traveling through the air layer 77 toward the +X side, and entering the first wavelength converter 51 travels through the air layer 77 while repeatedly reflected off the first optical layer 61 and the second optical layer 62, and then exits out of the region of the air layer 77, at a side of the second end surface 51d. Fluorescence Y17 emitted from the second wavelength converter 52, traveling through the air layer 77 toward the −X side, and entering the first wavelength converter 51 is reflected off the first reflection member 81, and exits out of the region of the air layer 77, at a side of the second end surface 51d. Note that the fluorescence Y17 is in some cases reflected off the first reflection member 81, then travels through the air layer 77 while repeatedly reflected off the second optical layer 62 and the first optical layer 61, and then exits out of the region of the air layer 77, at a side of the second end surface 51d.

As described above, the fluorescence Y as a result of conversion performed by the first wavelength converter 51 exits out of the light guide 76 configured with the air layer 77. The fluorescence Y1 as a result of conversion performed by the second wavelength converter 52 exits out of the light guide 76 configured with the air layer 77. That is, the fluorescence Y as a result of conversion performed by the first wavelength converter 51, and the fluorescence Y1 as a result of conversion performed by the second wavelength converter 52 travel through the light guide 76 and exit out of the region of the light guide 76, at a side of the second end surface 51d. The light source apparatus 30D can thus emit the yellow light WL containing the fluorescence Y as a result of conversion performed by the first wavelength converter 51 and the fluorescence Y1 as a result of conversion performed by the second wavelength converter 52 via the light extraction port 31k of the enclosure 31.

### Advantages of Fourth Embodiment

The present embodiment also provides advantages that are the same as those provided by the first embodiment, that is, the light source apparatus 30D allows the fluorescence Y and Y1 to propagate through the light guide 76 so that loss of the fluorescence Y and Y1 is small and the fluorescence Y and Y1 are used at excellent efficiency, and the light source apparatus 30D can efficiently output the illumination light WL.

In the present embodiment, since the light guide 76, which guides the fluorescence Y and Y1, is configured with the air layer 77, the following effects can be provided.

When the air layer 77 is disposed as the light guide 76 so as to be adjacent to the first wavelength converter 51 and the second wavelength converter 52 as in the present embodiment, the difference in refractive index between each of the wavelength converters 51 and 52 and the air layer 77 is about 0.7 because the refractive index of the YAG material of which the wavelength converters are made is about 1.7 and the refractive index of air is about 1.0. For example, when the first light transmissive member 73 is made of quartz (having refractive index of 1.4), the difference in refractive index between each of the wavelength converters 51 and 52 and the light guide 71 in the first embodiment is about 0.3, so that the difference in refractive index in the present embodiment is greater than the difference in refractive index in the first embodiment. The fluorescence Y and the fluorescence Y1 emitted from the wavelength converters 51 and 52 and entering the air layer 77 therefore travel in a direction inclining by a smaller angle with respect to the optical axis AX1 than in a case where the fluorescence Y and the fluorescence Y1 enter the first light transmissive member 73. The fluorescence Y and Y1 is emitted to the air layer 77 therefore travels along the optical axis AX1 and is readily extracted from the light extraction port 31K.

Furthermore, in the present embodiment, since the air layer 77 is exposed to the external space in the light extraction port 31k and has no interface where the refractive index changes, the fluorescence Y and Y1 having reached the light extraction port 31k exits to the external space without being reflected or refracted. The light source apparatus 30D according to the present embodiment, which provides the effects described above, can extract the fluorescence Y and Y1 at increased efficiency as compared with that in the first embodiment.

According to the configuration in the present embodiment, the first wavelength converter 51 and the second wavelength converter 52 are disposed so as to separate from each other, so that the wavelength converters 51 and 52 can be efficiently cooled. As a result, the rise in temperatures of the wavelength converters 51 and 52 can be suppressed, so that the high wavelength conversion efficiency can be maintained.

### Fifth Embodiment

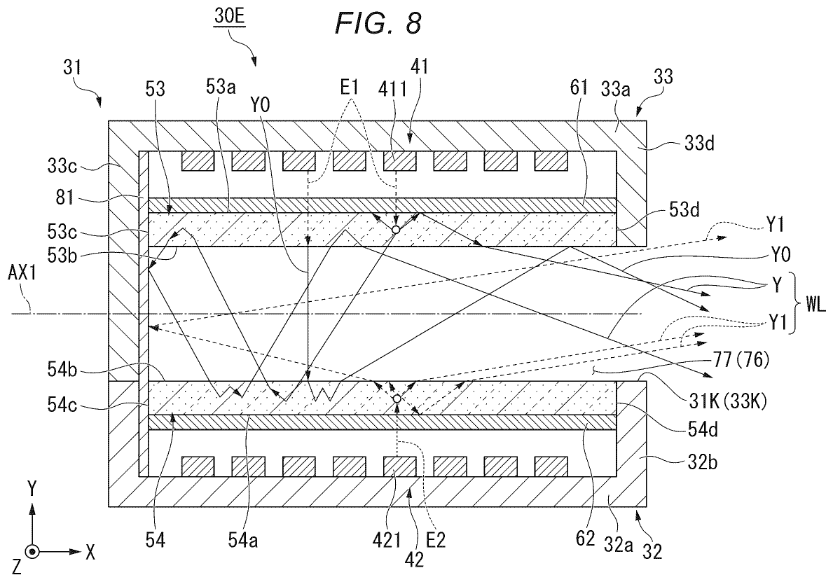

A fifth embodiment of the present disclosure will be described below with reference to FIG. 8.

The basic configuration of a light source apparatus according to the fifth embodiment is the same as that in the second embodiment, and the description of the basic configuration of the light source apparatus is therefore omitted.

FIG. 8 is a cross-sectional view of a light source apparatus 30E according to the fifth embodiment taken along the XY plane. In FIG. 8, the elements common to those in the drawings used in the second embodiment have the same reference characters and will not be described.

The light source apparatus 30E according to the present embodiment includes the enclosure 31, the first light source 41, the first wavelength converter 53, the first optical layer 61, the light guide 76 configured with the air layer 77, the second light source 42, the second wavelength converter 54, the second optical layer 62, the first reflection member 81, a third reflection member (not shown), and a fourth reflection member (not shown), as shown in FIG. 8.

The other configurations of the light source apparatus 30E are the same as those of the light source apparatus 30B according to the second embodiment.

### Advantages of Fifth Embodiment

The present embodiment, in which the light source apparatus 30E includes the first wavelength converter 53 and the second wavelength converter 54 each configured with a scattering phosphor, also provides advantages that are the same as those provided by the second embodiment, that is, the light source apparatus 30E allows loss of the fluorescence Y and Y1 to be reduced and the fluorescence Y and Y1 to be used at excellent efficiency, and the light source apparatus 30E can efficiently emits the illumination light WL.

Furthermore, in the present embodiment, since the fluorescence Y and the fluorescence Y1 are emitted from the wavelength converters 51 and 52 respectively in directions inclining by small angles with respect to the optical axis AX1 of the light guide 76 configured with the air layer 77, the efficiency at which the fluorescence Y and the fluorescence Y1 are extracted can be increased as compared with that in the second embodiment.

### Sixth Embodiment

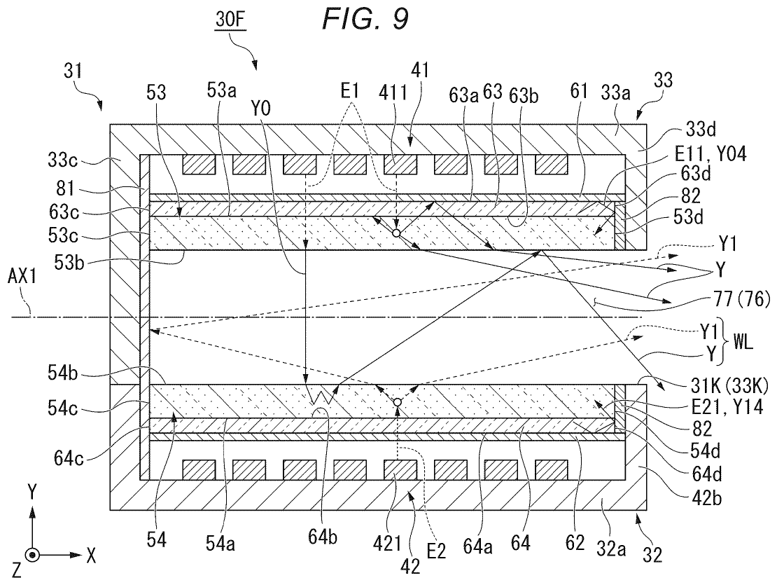

A sixth embodiment of the present disclosure will be described below with reference to FIG. 9.

The basic configuration of a light source apparatus according to the sixth embodiment is the same as that in the third embodiment, and the description of the basic configuration of the light source apparatus is therefore omitted.

FIG. 9 is a cross-sectional view of a light source apparatus 30F according to the sixth embodiment taken along the XY plane. In FIG. 9, elements common to those in the drawings used in the third embodiment have the same reference characters and will not be described.

The light source apparatus 30F according to the present embodiment includes the enclosure 31, the first light source 41, the first wavelength converter 53, the first optical layer 61, the second light transmissive member 63, the light guide 76, the second light source 42, the second wavelength converter 54, the second optical layer 62, the third light transmissive member 64, the first reflection member 81, the second reflection member 82, a third reflection member (not shown), and a fourth reflection member (not shown), as shown in FIG. 9.

The other configurations of the light source apparatus 30F are the same as those of the light source apparatus 30C according to the third embodiment.

### Advantages of Sixth Embodiment

The present embodiment, in which the light source apparatus 30F includes the second light transmissive member 63, the third light transmissive member 64, and the second reflective member 82, also provides advantages that are the same as those provided by the third embodiment, that is, the light source apparatus 30F allows loss of the fluorescence Y and Y1 to be reduced and the fluorescence Y and Y1 and excitation light to be used at excellent efficiency, and the light source apparatus 30F can efficiently emits the illumination light WL.

Furthermore, in the present embodiment, since the fluorescence Y and the fluorescence Y1 are emitted from the wavelength converters 51 and 52 respectively in directions inclining by small angles with respect to the optical axis AX1 of the light guide 76 configured with the air layer 77, the efficiency at which the fluorescence Y and the fluorescence Y1 are extracted can be increased as compared with that in the third embodiment.

Note that the technical scope of the present disclosure is not limited to the embodiments described above, and various changes can be made thereto without departing from the intent of the present disclosure.

For example, in the embodiments described above, the material of which the first wavelength converter is made may be a composite phosphor containing AlN and Ce:YAG. According to the configuration described above, even when the contact area between the first wavelength converter and the enclosure is too small to secure a large number of heat dissipation paths, the thermal conductivity of the first wavelength converter can be increased as compared with a case where a phosphor made only of Ce:YAG is used. The efficiency of cooling the first wavelength converter is thus increased. Accordingly, the maximum amount of the first excitation light can be increased, and the maximum output of the yellow fluorescence can be increased. Similarly, the second wavelength converter may be configured with a composite phosphor.

The light source apparatuses according to the embodiments described above each include the second light source, and may each include only the first light source. In this case, the second wavelength converter converts the first excitation light having been emitted from the first light source and having passed through the first optical layer, the first wavelength converter, and the light guide into the yellow fluorescence.

In addition, the specific description of the shapes, the numbers, the arrangements, the materials, and other factors of the elements of the light source apparatuses and the projector are not limited to those in the embodiments described above, and can be changed as appropriate. The aforementioned embodiments have been described with reference to the case where any of the light source apparatuses according to the present disclosure is incorporated in a projector using liquid crystal panels, but not necessarily. Any of the light source apparatuses according to the present disclosure may be incorporated in a projector using digital micromirror devices as the light modulators. The projector may not include multiple light modulators, and may include only one light modulator.

The aforementioned embodiments have been described with reference to the case where any of the light source apparatuses according to the present disclosure is incorporated in a projector, but not necessarily. Any of the light source apparatuses according to the present disclosure may be incorporated in a lighting instrument, a headlight of an automobile, and other instruments.

### SUMMARY OF PRESENT DISCLOSURE

The present disclosure is summarized below as additional remarks.

### Additional Remark 1

A light source apparatus including:
a first light source configured to emit first light having a first wavelength band;
a first wavelength converter configured to convert the first light into second light having a second wavelength band different from the first wavelength band;
a first optical layer disposed between the first light source and the first wavelength converter and configured to transmit the first light and reflect the second light;
a light guide disposed on a side opposite the first optical layer with the first wavelength converter disposed therebetween and configured to guide the second light as a result of conversion performed by the first wavelength converter;
a second wavelength converter disposed on a side opposite the first wavelength converter with the light guide disposed therebetween and configured to convert the first light incident via the first wavelength converter and the light guide into third light having a third wavelength band different from the first wavelength band;
a second optical layer disposed on a side opposite the light guide with the second wavelength converter disposed therebetween and configured to reflect the second light and the third light; and
a first reflection member configured to reflect the first light, the second light, and the third light,
wherein the first wavelength converter has a first surface on which the first light is incident via the first optical layer, and a second surface and a third surface that intersect with the first surface and face opposite sides,
the first reflection member is disposed in a region of the light guide, at a side of the second surface, and
the second light as a result of conversion performed by the first wavelength converter and the third light as a result of conversion performed by the second wavelength converter travel through the light guide and exit via a region of the light guide, at a side of the third surface.

According to the thus configured light source apparatus, since the second light and the third light propagate through the light guide, loss of the second light and the third light is reduced, and the second light and the third light are used at excellent efficiency. Furthermore, a light source apparatus capable of efficiently emitting illumination light containing the second light and the third light can be realized.

### Additional Remark 2

The light source apparatus according to Additional Remark 1, further including
an enclosure configured to house the first optical layer, the second optical layer, the first wavelength converter, and the second wavelength converter,
wherein the enclosure has a light extraction port via which the second light and the third light emitted from the region of the light guide, at the side of the third surface are extracted out of the enclosure, and
in a plan view viewed in a direction of a normal to the third surface of the first wavelength converter, the light extraction port overlaps the light guide.

According to the configuration described above, the enclosure can protect the first optical layer, the second optical layer, the first wavelength converter, and the second wavelength converter, and allows the second light and the third light propagating through the interior of the light guide to be extracted as the illumination light out of the enclosure via the light extraction port thereof. Since the light extraction port does not allow the second light and the third light having relatively low illuminance and emitted via an end surface of the first wavelength converter, at the side of the third surface to be extracted out of the enclosure, the uniformity of the illuminance distribution of the illumination light that exits via the light extraction port can be enhanced.

### Additional Remark 3

The light source apparatus according to Additional Remark 1 or 2, wherein
a first light transmissive member configured to transmit the first light, the second light, and the third light is disposed at the light guide, and
the second light as a result of conversion performed by the first wavelength converter and the third light as a result of conversion performed by the second wavelength converter travel through an interior of the first light transmissive member and exits via an end surface of the first light transmissive member, at an side of the third surface.

According to the configuration described above, since the first light transmissive member is disposed at the light guide, the difference in refractive index between each of the wavelength converters and the light guide is smaller and the critical angle at the interface between each of the wavelength converters and the light guide is therefore smaller than those in a configuration in which the light guide is configured with an air layer. The second light and the third light generated by the wavelength converters can therefore be readily extracted to the light guide, so that loss of the second light and the third light due to reabsorption thereof can be suppressed.

### Additional Remark 4

The light source apparatus according to any one of Additional Remarks 1 to 3, further including
a second light transmissive member disposed between the first wavelength converter and the first optical layer.

According to the configuration described above, forming the first optical layer at the second light transmissive member having the shape of a planar plate allows formation of the first optical layer configured with a planar film unlike a case where the first optical layer is formed at the surface of the first wavelength converter, so that the optical characteristics of the first optical layer can be readily improved. Furthermore, heat generated in the first wavelength converter can be dissipated via the second light transmissive member. The performance of cooling the first wavelength converter can therefore be enhanced.

### Additional Remark 5

The light source apparatus according to Additional Remark 4, further including:
an enclosure configured to house the first optical layer, the second optical layer, the first wavelength converter, the second wavelength converter, and the second light transmissive member; and
a second reflection member configured to reflect the first light, the second light, and the third light,
wherein the enclosure has a light extraction port via which the second light and the third light emitted from a region of the light guide, at a side of the third surface are extracted out of the enclosure,
the light extraction port overlaps the light guide in a plan view viewed in a direction of a normal to the third surface of the first wavelength converter, and
the second reflection member is disposed between the enclosure and an end surface of the first wavelength converter, at an side of the third surface and between the enclosure and an end surface of the second light transmissive member, at an side of the third surface.

According to the configuration described above, the enclosure can protect the first optical layer, the second optical layer, the first wavelength converter, the second wavelength converter, and the second light transmissive member, and allows the second light and the third light propagating through the interior of the light guide to be extracted as the illumination light out of the enclosure via the light extraction port thereof.

The first light or the second light having been scattered in the first wavelength converter and having propagated through the interior of the second light transmissive member can be reflected off the second reflection member and caused to enter the first wavelength converter. The first light having entered the first wavelength converter is used to excite a phosphor to cause it to emit the second light, and the second light having entered the first wavelength converter is scattered and exits out of the light guide. The first light and the second light propagating through the interior of the second light transmissive member can therefore be efficiently extracted from the second light transmissive member and used.

### Additional Remark 6

The light source apparatus according to Additional Remark 1 or 2, wherein
the light guide is an air layer, and
the second light as a result of conversion performed by the first wavelength converter and the third light as a result of conversion performed by the second wavelength converter travel through the air layer and exit via a region of the air layer, at a side of the third surface.

According to the configuration described above, since the difference in refractive index between each of the wavelength converters and the light guide is greater than that in a configuration in which the second light and the third light enter the light transmissive member, so that the second light and the third light each travel in a direction inclining by a small angle with respect to the longitudinal direction of the corresponding wavelength converter. Furthermore, since the air layer is exposed to the external space on the side of the third surface and has no interface where the refractive index changes, the second light and the third light having reached the region of the third surface are not reflected or refracted but directly exit to the external space. The efficiency at which the second light and the third light are extracted can therefore be increased.

### Additional Remark 7

The light source apparatus according to any one of Additional Remarks 1 to 6, further including
a third reflection member and a fourth reflection member configured to reflect the first light, the second light, and the third light,
wherein the first wavelength converter has a fourth surface and a fifth surface that intersect with the first surface, the second surface, and the third surface and face opposite sides,
the third reflection member is disposed in a region of the light guide, at a side of the fourth surface, and
the fourth reflection member is disposed in a region of the light guide, at a side of the fifth surface.

According to the configuration described above, the third reflection member and the fourth reflection member can increase the conversion efficiency from the first light to the second light and the conversion efficiency from the first light to the third light. The configuration described above can further suppress loss of each of the multiple types of light resulting from the light output via the fourth surface and the fifth surface and absorbed by the enclosure.

### Additional Remark 8

The light source apparatus according to any one of Additional Remarks 1 to 7, wherein
the first wavelength converter and the second wavelength converter are each configured with a transparent phosphor.

According to the configuration described above, the second light and the third light can be efficiently extracted out of the light guide via the third surface thereof even when the first wavelength converter and the second wavelength converter are each configured with a transparent phosphor.

### Additional Remark 9

The light source apparatus according to any one of Additional Remarks 1 to 8, wherein
the first wavelength converter and the second wavelength converter are each configured with a phosphor that scatters light.

The configuration described above, in which the traveling directions of the second light and the third light to various directions change because the second light and the third light are scattered in the wavelength converters and the second light and the third light propagate through the interior of the light guide, can efficiently output the second light and the third light via the third surface. Loss of the second light and the third light is therefore suppressed, so that the efficiency at which the second light and the third light are extracted can be further increased.

### Additional Remark 10

The light source apparatus according to Additional Remark 9, wherein
the first wavelength converter and the second wavelength converter each contain a yellow phosphor,
the first light is blue light,
the second light and the third light are yellow fluorescence, and
the fluorescence propagates through the light guide while repeatedly undergoing at least one of scattering in the first wavelength converter, reflection at the first optical layer, scattering in the second wavelength converter, and reflection at the second optical layer, and exits via a region of the light guide, at a side of the third surface.

According to the configuration described above, yellow fluorescence generated by the first wavelength converter and the second wavelength converter can be efficiently extracted via the third surface of the light guide.

### Additional Remark 11

The light source apparatus according to any one of Additional Remarks 1 to 10, further including
a second light source disposed on a side opposite the light guide with the second wavelength converter disposed therebetween and configured to emit the first light,
wherein the second wavelength converter is configured to convert the first light emitted from the second light source, passing through the second optical layer, and entering the second wavelength converter into the third light.

The configuration described above allows the first light emitted from the second light source to enter the second wavelength converter. The amount of the third light emitted from the second wavelength converter can thus be increased.

### Additional Remark 12

A projector including:
the light source apparatus according to any one of Additional Remarks 1 to 11;
a light modulator configured to modulate light emitted from the light source apparatus; and
a projection optical apparatus configured to project the light modulated by the light modulator.

The thus configured projector, which includes the light source apparatus configured to efficiently extract light, can be a projector that excels in light use efficiency.

What is claimed is:

1. A light source apparatus comprising:
a first light source configured to emit first light having a first wavelength band;
a first wavelength converter configured to convert the first light into second light having a second wavelength band different from the first wavelength band;
a first optical layer disposed between the first light source and the first wavelength converter and configured to transmit the first light and reflect the second light;
a light guide disposed on a side opposite the first optical layer with the first wavelength converter disposed therebetween and configured to guide incident light;
a second wavelength converter disposed on a side opposite the first wavelength converter with the light guide disposed therebetween and configured to convert the first light incident via the first optical layer, the first wavelength converter, and the light guide into third light having a third wavelength band different from the first wavelength band;
a second optical layer disposed on a side opposite the light guide with the second wavelength converter disposed therebetween and configured to reflect the second light and the third light; and
a first reflection member configured to reflect the first light, the second light, and the third light,
wherein the first wavelength converter has a first surface on which the first light is incident via the first optical layer, and a second surface and a third surface that intersect with the first surface and face opposite sides,
the first reflection member is disposed in a region of the light guide, at a side of the second surface, and
the second light as a result of conversion performed by the first wavelength converter and the third light as a result of conversion performed by the second wavelength converter travel through the light guide and exit via a region of the light guide, at a side of the third surface.

2. The light source apparatus according to claim 1, further comprising
an enclosure configured to house the first optical layer, the second optical layer, the first wavelength converter, and the second wavelength converter,
wherein the enclosure has a light extraction port via which the second light and the third light emitted from the region of the light guide, at the side of the third surface are extracted out of the enclosure, and
in a plan view viewed in a direction of a normal to the third surface of the first wavelength converter, the light extraction port overlaps the light guide.

3. The light source apparatus according to claim 1, wherein
a first light transmissive member configured to transmit the first light, the second light, and the third light is disposed at the light guide, and
the second light as a result of conversion performed by the first wavelength converter and the third light as a result of conversion performed by the second wavelength converter travel through an interior of the first light transmissive member and exit via an end surface of the first light transmissive member, at an side of the third surface.

4. The light source apparatus according to claim 1, further comprising
a second light transmissive member disposed between the first wavelength converter and the first optical layer.

5. The light source apparatus according to claim 4, further comprising:
an enclosure configured to house the first optical layer, the second optical layer, the first wavelength converter, the second wavelength converter, and the second light transmissive member; and
a second reflection member configured to reflect the first light, the second light, and the third light,
wherein the enclosure has a light extraction port via which the second light and the third light emitted from a region of the light guide, at a side of the third surface are extracted out of the enclosure,
the light extraction port overlaps the light guide in a plan view viewed in a direction of a normal to the third surface of the first wavelength converter, and
the second reflection member is disposed between the enclosure and an end surface of the first wavelength converter, at an side of the third surface and between the enclosure and an end surface of the second light transmissive member, at an side of the third surface.

6. The light source apparatus according to claim 1, wherein
the light guide is an air layer, and
the second light as a result of conversion performed by the first wavelength converter and the third light as a result of conversion performed by the second wavelength converter travel through the air layer and exit via a region of the air layer, at a side of the third surface.

7. The light source apparatus according to claim 1, further comprising
a third reflection member and a fourth reflection member configured to reflect the first light, the second light, and the third light,
wherein the first wavelength converter has a fourth surface and a fifth surface that intersect with the first surface, the second surface, and the third surface and face opposite sides,
the third reflection member is disposed in a region of the light guide, at a side of the fourth surface, and
the fourth reflection member is disposed in a region of the light guide, at a side of the fifth surface.

8. The light source apparatus according to claim 1, wherein
the first wavelength converter and the second wavelength converter are each configured with a transparent phosphor.

9. The light source apparatus according to claim 1, wherein
the first wavelength converter and the second wavelength converter are each configured with a phosphor that scatters light.

10. The light source apparatus according to claim 9, wherein
the first wavelength converter and the second wavelength converter each contain a yellow phosphor,
the first light is blue light,
the second light and the third light are yellow fluorescence, and
the fluorescence propagates through the light guide while repeatedly undergoing at least one of scattering in the first wavelength converter, reflection at the first optical layer, scattering in the second wavelength converter, and reflection at the second optical layer, and exits via a region of the light guide, at a side of the third surface.

11. The light source apparatus according to claim 1, further comprising
a second light source disposed on a side opposite the light guide with the second wavelength converter disposed therebetween and configured to emit the first light,
wherein the second wavelength converter is configured to convert the first light emitted from the second light source, passing through the second optical layer, and entering the second wavelength converter into the third light.

12. A projector comprising:
the light source apparatus according to claim 1;
a light modulator configured to modulate light emitted from the light source apparatus; and
a projection optical apparatus configured to project the light modulated by the light modulator.
